(19) United States
(12) Patent Application Publication
(10) Pub. No.: US 2016/0107892 A1
(43) Pub. Date: Apr. 21, 2016

(54) METHOD FOR SEPARATING HF FROM HF/HALOGENATED HYDROCARBON MIXTURES USING IONIC LIQUIDS

(71) Applicant: HONEYWELL INTERNATIONAL INC., Morristown, NJ (US)

(72) Inventors: Haiyou WANG, Amherst, NY (US); Hsueh Sung TUNG, Getzville, NY (US)

(73) Assignee: HONEYWELL INTERNATIONAL INC., Morristown, NJ (US)

(21) Appl. No.: 14/884,354

(22) Filed: Oct. 15, 2015

Related U.S. Application Data
(60) Provisional application No. 62/064,544, filed on Oct. 16, 2014.

(51) Int. Cl. C01B 7/19

(52) U.S. Cl. CPC C01B 7/195

(57) ABSTRACT

The present invention relates to an ionic liquid comprised of a salt, the anion of which is Cl⁻, F⁻, and (HF)ₙF⁻(n=1.0−4.0), or combination thereof. In another embodiment, the present invention relates to a process of separating HF from a first mixture comprised of at least one halogenated hydrocarbon and HF which comprises contacting the mixture with an ionic liquid comprised of a salt, the anion of which is Cl⁻, F⁻, and (HF)ₙF⁻ where n is a positive number ranging from 1 to 4, inclusive 4.0), to form a second mixture comprised of HF, halogenated hydrocarbon and said ionic liquid, extracting a solution comprising HF therefrom, and recovering HF therefrom.

### CROSS REFERENCES TO RELATED APPLICATION

The present application claims benefit of provisional application U.S. Ser. No. 62/064,544, filed on Oct. 16, 2014.

### FIELD OF INVENTION

The present invention provides methods of recovering anhydrous hydrogen fluoride from a product stream comprising hydrogen fluoride and at least one halogenated hydrocarbon compound by means of extraction with an ionic liquid.

### BACKGROUND OF THE INVENTION

Hydrofluorocarbons (HFCs), hydrofluoroolefins (HFOs), hydrochlorofluorocarbons (HCFCs), and hydrochlorofluoroolefins (HCFOs) are highly desirable for use in a wide range of applications, including, but not limited to, solvents, refrigerants, blowing agents, aerosol propellants, and the like. Because HFCs, HFOs, HCFCs, and HCFOs tend to exhibit lesser (or no) ozone-depleting characteristics and tend to be less flammable and less toxic than many chlorine-containing compounds (such as hydrochlorocarbons or chlorofluorocarbons) used conventionally in the aforementioned applications, HFCs, HFOs, HCFCs, and HCFOs have found increasing use as substitutes for conventional chlorine-containing compounds. In light of such increasing use, applicants have recognized a growing need for an efficient and cost-effective production of HFCs, HFOs, HCFCs, and HCFOs.

In fluorine chemistry, anhydrous HF is widely used as fluorination agent to prepare HFCs, HCFCs, HFOs, and HCFOs. For examples, anhydrous HF is used in the following reactions: 1) CHCl₃+HF→CHClF₂ (HCFC-22)+HCl, 2) CCl₃CH₂Cl+HF→CF₃CH₂F (HFC-134a)+HCl, 3) CCl₂═CCl₂+HF→CF₃CHF₂ (HFC-125)+HCl, 4) CCl₃CH₂CHCl₂+HF→CF₃CH₂CHF₂ (HFC-245fa)+HCl, 5) CCl₂═CClCH₂Cl+HF→CF₃CCl═CH₂(HCFO-1233xf)+HCl, and 6) CF₃CCl═CH₂ (HCFO-1233xf)+HF→CF₃CClFCH₃ (HCFC-244bb). An excessive amount of HF is often used to drive the conversion of raw material. As a result, HF is often present together with HFC/HCFC/HFO/HCFO (either as an intermediate or product). On the other hand, dehydrofluorination is sometimes used to prepare HFOs and HCFOs, generating HF. For instance, HF is generated in the following processes: 1) CF₃CH₂CHF₂ (HFC-245fa)→CF₃CH═CHF (HFO-1234ze)+HF, 2) CF₃CHFCH₂F (HFC-245eb)→CF₃CF═CH₂ (HFO-1234yf)+HF, 3) CF₃CHFCHF₂ (HFC-236ea)→CF₃CF═CHF (HFO-1225ye)+HF, 4) CF₃CH₂CHClF→CF₃CH═CHCl (HCFO-1233zd)+HF, and 5) CF₃CClFCH₃→CF₃CCl═CH₂ (HCFO-1233xf)+HF. As a result, HF is present in a product stream together with the generated HFO/HCFO. HF is preferably to be recovered with relatively high purity so that it can be directly recycled and reused.

Unfortunately, while some relatively pure HF can be recovered and separated from the product streams using conventional distillation techniques, there is usually a significant portion of HF which cannot be separated, especially where the HF forms an azeotropic or azeotrope-like mixture with the target HFC/HFO/HCFC/HCFO product in a product stream. In addition, while conventional aqueous scrubbing techniques can be used to remove HF from an HFC/HFO/HCFC/HCFO product stream to produce purified HFC/HFO/HCFC/HCFO product, such techniques are destructive to the HF, thereby decreasing the amount of HF for recycling and thus, making the process less efficient and more costly, as the lost HF needs to be replaced.

In an attempt to avoid at least some of the aforementioned problems associated with distillation and aqueous scrubbing, the prior art has suggested a number of methods of separating HF and/or HFC/HFO/HCFC/HCFO products from azeotrope-like mixtures thereof. For example, European Patent Application EP 472,391 discloses a method of separating 1,1,1,2-tetrafluoroethane (HFC-134a) from a mixture containing hydrochlorofluorocarbons using an extraction agent such as trichloroethylene or perchloroethylene, among others. European Patent Application EP 467,531 discloses a method of separating HFC-134a from a mixture of HFC-134a and HF by passing the mixture through a distillation column to form a residue of pure HFC-134a. U.S. Pat. No. 5,211,817 discloses a process of separating fluorocarbons from azeotropic mixtures with HF by column distillation wherein a vapor sidestream is withdrawn and the sidestream is introduced into a rectifying column equipped with a condenser which is operated at a high reflux ratio. U.S. Pat. Nos. 4,944,846, 5,918,481, and 6,328,907 attempt to use pressure swing distillation to achieve separation of azeotropic mixtures of HFCs/HCFCs and HF. Unfortunately, the aforementioned methods tend to exhibit limited effectiveness in separation and/or are cost prohibitive.

U.S. Pat. No. 5,895,639 discloses a method of separating hydrogen fluoride from a fluorocarbon/hydrogen fluoride azeotropic mixture using sulfuric acid, particularly concentrated sulfuric acid (about 98 wt. % or greater). U.S. Pat. No. 7,371,363 discloses a similar method of separating hydrogen fluoride from a mixture comprising hydrogen fluoride and at least one halogenated hydrocarbon with a solution of less than about 93 wt.% sulfuric acid in water. While these methods may offer some advantages in HF separation over the aforementioned conventional separation methods, nevertheless such recovered anhydrous HF often contains small amount of sulfuric acid and may require further treatment to reduce the sulfuric acid level.

The present invention provides a better way to recover HF by using ionic liquids.

### SUMMARY OF THE INVENTION

The present invention relates to an ionic liquid comprised of a salt, the anion of which is chloride (Cl⁻), fluoride (F⁻), oligomeric fluorohydrogenate ions, (HF)ₙF⁻ (n=1.0−4.0), or combination thereof In another embodiment, the present invention relates to a process of separating HF from a first mixture comprised of at least one halogenated hydrocarbon and HF which comprises contacting the mixture with an ionic liquid comprised of a salt, the anion of which is Cl⁻, F⁻, (HF)ₙF⁻ wherein n is a positive number ranging from 1 to 4, inclusive, to form a second mixture comprised of HF, halogenated hydrocarbon and said ionic liquid, extracting a solution comprising HF therefrom, and recovering HF therefrom.

### DETAILED DESCRIPTION OF AN EMBODIMENT

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

In an embodiment of the present invention, the method of the present invention requires mixing an ionic liquid with a mixture comprising HF and at least one halogenated hydrocarbon. The term “hydrocarbon” refers to an organic molecule which may be saturated or may contain one or more carbon-carbon multiple bonds (double or triple bonds or combination thereof) and which may be straight chained or branched. The hydrocarbon contains carbon atoms, hydrogen atoms, and optionally chlorine, fluorine, 1 or more carbon-carbon double bonds, and/or one or more carbon-carbon triple bonds. In an embodiment, the term includes molecules that contain from one to six carbon atoms.

As used herein, the term “halogenated hydrocarbon” refers generally to a hydrocarbon compound having at least one halogen substituent thereon. By halogen, it is meant bromo, iodo, chloro and fluoro. In another embodiment, the halogen substituted on the halogenated hydrocarbon compounds described in the present application is fluoro or chloro. In another embodiment, the halogenated hydrocarbon contains at least one fluorine atom. If two or more halogens are present on the halogenated hydrocarbon, the halogens may be the same or different and may be substituted on the same carbon atoms, adjacent carbon atoms or on non-adjacent carbon atoms. In an embodiment, one of the halogens is fluorine, while the others may all be fluorine or a combination of fluorine and chlorine substituents. In an embodiment, the halogenated hydrocarbons contain from one to six carbon atoms. The halogenated hydrocarbon may be straight chained or branched. In addition, the halogenated hydrocarbon may be completely saturated or contain one or more carbon-carbon double bonds or triple bonds. In an embodiment, the halogenated hydrocarbon is a straight chained or branched, saturated halogenated hydrocarbon or a halogenated hydrocarbon containing one or two carbon-carbon double bonds. In another embodiment, the halogenated hydrocarbon is saturated or contains one carbon-carbon double bonds.

Thus, the halogenated hydrocarbons include hydrofluorocarbons (HFCs), hydrofluoroolefins (HFOs), hydrochlorofluorocarbons (HCFCs), hydrochlorofluoroolefins (HCFOs), and the like.

As used herein, the term “hydrofluorocarbon” refers to a straight-chained or branched hydrocarbon containing carbon, hydrogen, fluorine atoms and optionally chlorine atoms. The term “fluoroolefin”, as used herein, means a hydrocarbon containing hydrogen, carbon, fluorine, and a carbon-carbon double bond, and optionally a chlorine atom. The term “hydrofluoroolefin”, as used herein, means a hydrocarbon containing hydrogen, carbon, fluorine, and a carbon-carbon double bond. The term “hydrochlorofluorocarbon”, as used herein, refers to a straight-chained or branched hydrocarbon containing carbon, hydrogen, chlorine, and fluorine; it may be saturated or contain one or more carbon-carbon multiple bonds, such as carbon-carbon double bond. The term “fluoroalkane”, as used herein, refers to a saturated hydrocarbon having two or more carbon atoms containing hydrogen, carbon, fluorine, and optionally chlorine, whereby a fluorine atom and a hydrogen atom are substituted on two adjacent carbon atoms.

Thus, as defined herein, the term “halogenated hydrocarbon” includes hydrofluorocarbons, hydrofluoroolefins, hydrochlorofluorocarbons, hydrochlorofluoroolefins, and mixtures thereof. Examples of suitable HFCs include 1,1,1,3,3-pentafluoropropane (HFC-245fa), 1,1,1,2,3-pentafluoropropane (HFC-245eb), 1,1,1,2,2-pentafluoropropane (HFC-245cb), 1,1,1,2-tetrafluoroethane (HFC-134a), 1,1,1-trifluoroethane (HFC-143a), pentafluoroethane (HFC-125), 1,1,1,3,3-pentafluorobutane (HFC-365mfc), 1,1,1,3,3,3-hexafluoropropane (HFC-236fa), difluoromethane (HFC-32), mixtures of two or more thereof, and the like. Thus, HFCs include HFC-245fa, HFC-245eb, and the like. Examples of suitable HFOs include 2,3,3,3-tetrafluoropropene (HFO-1234yf), 1,3,3,3-tetrafluoropropene (HFO-1234ze), and 1,2,3,3,3-pentafluoropropene (HFO-1225ye), mixtures of two or more thereof, and the like. Thus, HFOs include HFO-1234yf, HFO-1234ze, and the like. Examples of suitable HCFCs include 1-chloro-1,2,2,2-tetrfluoroethane (HCFC-124), 1,1-dichloro-2,2,2-trifluoroethane (HCFC-123), chlorodifluoromethane (HCFC-22), 2-chloro-1,1,1,2-tetrafluoropropane (HCFC-244bb), 3-chloro-1,1,1,3-tetrafluoropropane (HCFC-244fa), mixtures of two or more thereof, and the like. Thus, HCFCs include HCFC-244bb, HCFC-244fa, and the like. Examples of suitable HCFOs include 1-chloro-3,3,3-trifluoropropene (HCFO-1233zd), 2-chloro-3,3,3-trifluoropropene (HCFO-1233xf), 2,3-dichloro-3,3-difluoropropene (HCFO-1232xf), mixtures of two or more thereof, and the like. Thus, HCFOs include HCFO-1233zd, HFO-1233xf, and the like.

The HF and halogenated hydrocarbon(s) present in the provided mixture may be present in any amounts. In certain embodiments, the HF and halogenated hydrocarbon are present in amounts sufficient to produce an azeotropic or azeotrope-like relationship between at least a portion of the HF and halogenated hydrocarbon. In other embodiments, the HF and halogenated hydrocarbon are present only in non-azeotropic or non-azeotrope-like amounts.

The mixture comprising a halogenated hydrocarbon and HF may result from a reaction product mixture obtained by reacting HF with a chlorinated hydrocarbon to form a hydrofluorocarbon. The reaction may be a substitution reaction in which a leaving group on the hydrocarbon molecule, such as chlorine, is substituted with a fluorine atom using techniques known in the art. Alternatively, the reaction may be an HF addition across a carbon-carbon double bond. Thus, for example, the reaction product mixture for use in the present invention is produced by a process comprising the reaction of HF with an HCFC or a hydrochlorocarbon (HCC) to produce an HFC, HCFC, HCFO, HFO, or combinations of two or more thereof.

Table 1 below shows a number of chlorinated starting compounds and the HFC, HCFC, HCFO, or HFO products that can be produced by reacting the starting compounds with HF. The reaction may be conducted in the presence or absence of a fluorination catalyst. Suitable catalysts include, but are not limited to chromium, aluminum, cobalt, manganese, nickel and iron oxides, hydroxides, halides, oxyhalides, inorganic salts thereof and their mixtures. Combinations of catalysts suitable for the present invention nonexclusively include Cr₂O₃, FeCl₃/C, Cr₂O₃/Al₂O₃, Cr₂O₃/AlF₃, Cr₂O₃/carbon, CoCl₂/Cr₂O₃/Al₂O₃, NiCl₂/Cr₂O₃/Al₂O₃, CoCl₂/AlF₃, NiCl₂/AlF₃ and mixtures thereof. Chromium oxide/aluminum oxide catalysts are described in U.S. Pat. No. 5,155,082 which is incorporated herein by reference. Chromium (III) oxides such as crystalline chromium oxide or amorphous chromium oxide are preferred with amorphous chromium oxide being most preferred. Chromium oxide (Cr₂O₃) is a commercially available material which may be purchased in a variety of particle sizes. Fluorination catalysts having a purity of at least 98% are preferred. If present, the fluorination catalyst is present in an excess but in at least an amount sufficient to drive the reaction. The reaction is conducted under effective conditions known to one of ordinary skill in the art.

In certain embodiments, these reactions may be followed by a dehydrohalogenation reaction, under dehydrohalogenation conditions known to one of ordinary skill in the art in which a carbon atom and halogen atom on adjacent carbons atoms are removed, resulting in the formation of a carbon-carbon double bond. Any of such chlorinated starting materials can be reacted to provide a product mixture comprising hydrochloride and an HCFO or an HFO as shown suitable for use in the present invention. A catalyst may be present. The catalysts here may be metal halides, halogenated metal oxides, neutral (or zero oxidation state) metal or metal alloy, or activated carbon in bulk or supported form. When metal halides or metal oxides catalysts are used, preferably mono-, bi-, and tri-valent metal halides, oxide and their mixtures/combinations, and more preferably mono- and bi-valent metal halides and their mixtures/combinations may be utilized. Component metals include, but are not limited to, Cr³⁺, Fe³⁺, Mg²⁺, Ca²⁺, Ni²⁺, Zn²⁺, Pd²⁺, Li⁺, Na⁺, K⁺, and Cs⁺. Component halogens include, but are not limited to, F⁻, Cl⁻, Br⁻, and F. Examples of useful mono- or bi-valent metal halide include, but are not limited to, LiF, NaF, KF, CsF, MgF₂, CaF₂, LiCl, NaCl, KCl, and CsCl. When neutral, i.e., zero valent, metals, metal alloys and their mixtures are used. Useful metals include, but are not limited to, Pd, Pt, Rh, Fe, Co, Ni, Cu, Mo, Cr, Mn, and combinations of the foregoing as alloys or mixtures. The catalyst may be supported or unsupported. Useful examples of metal alloys include, but are not limited to, SS 316, Monel 400, Inconel 825, Inconel 600, and Inconel 625. Examples of catalysts include activated carbon, stainless steel (e.g. SS 316), austenitic nickel-based alloys (e.g. Inconel 625), nickel, fluorinated 10% CsCl/MgO, and 10% CsCl/MgF₂. The reactions are conducted under dehyrohalogenation conditions known to one of ordinary skill in the art.

Table 1 lists exemplary reactions in which HF is utilized and reacted with halogenated hydrocarbon under substitution reaction conditions; some of the reactions listed are followed by dehydrohalogenation reactions. In such embodiments, in addition to HF and at least one HFC or HCFC or HCFO or HFO, the provided mixture may further contain other unreacted starting materials, by-products, and/or impurities from the reaction source. Although the mixture may contain catalyst, in an embodiment, the catalyst is removed prior to mixing with the ionic liquid.

TABLE 1

| | HFC/HCFC/HCFO/HFO formed via reaction with |
|---|---|
| Starting material | HF |
| 1,1,1,3,3-pentachloropropane | HFC-245fa, HCFO-1233zd, HFO-1234ze |
| | 1,1,1,3,3-pentafluoropropane, 1-chloro-3,3,3- |
| | trifluoropropene, 1,3,3,3-tetrafluoropropene, |
| 1,1,2,3-tetrachloropropene | HCFO-1232xf, HCFO-1233xf |
| | 2,3-dichloro-3,3-difluoropropene, 2-chloro-3,3,3- |
| | trifluoropropene |
| HCFO-1233xf | HCFC-244bb, HFC-245cb |
| 2-chloro-3,3,3-trifluoropropene | 2-chloro-1,1,1,2-tetraflurorpropane, 1,1,1,2,2- |
| | pentafluoropropane |
| 1,1,1,2-tetrachlorethane | HFC-134a |
| | 1,1,1,2-tetrafluoroethane |
| perchloroethylene | HFC-125, HCFC-123, HCFC-124 |
| | 2,2-dichloro-1,1,1-trifluoroethane, 2-chloro-1,1,1,2- |
| | tetrafluoroethane, 1,1,1-trifluoroethane, |
| 1,1,1-trichloroethane | 143a |
| | 1,1,1-trifluoroethane |
| chloroform | HCFC-22 |
| | chlorodiflurormethane |
| Methylene chloride | HFC-32 |
| | difluoromethane |
| 1,1,1,3,3,3-hexachloropropane | HFC-236fa |
| | 1,1,1,3,3,3-hexafluoropropane |
| 1,1,1,3,3-pentachlorobutane | HFC-365mfc |
| | 1,1,1,3,3-pentafluorobutane |

In other embodiments, the mixture comprises a reaction product mixture obtained by a process comprising dehydrofluorinating a starting compound to form a halogenated hydrocarbon and HF. For example, the reaction product mixture for use in the present invention is produced by a process comprising the dehydrofluorination reaction of an HCFC or an HFC to produce HF and an HCFO or an HFO, or combinations of two thereof. Table 2 below shows a number of fluorinated starting compounds and the HCFO, or HFO products that can be produced together with HF by dehydrofluorinating the starting compounds. Any of such fluorinated starting materials can be reacted to provide a product mixture comprising HF and an HCFO or an HFO as shown suitable for use in the present invention. The reactions are conducted under dehydrofluorinating conditions known in the art. A catalyst may or may not be present. If present, the catalyst is present in effective amounts. Examples of suitable catalysts include fluorinated chromia (fluorinated Cr₂O₃), fluorinated alumina (fluorinated Al₂O₃), fluorinated lanthanum oxide, fluoride or oxyfluoride of magnesium, zinc, or mixtures of magnesium and zinc, activated carbon, metal fluorides (e.g., CrF₃, AlF₃), and carbon supported transition metals (zero oxidation states), such as Fe/C, Co/C, Ni/C, Pd/C or transition metal halides.

The embodiments listed in Table 2 are exemplary dehydrofluorination reaction. In addition to HF and at least one HCFO or HFO, the provided mixture may further contain other unreacted starting materials, by-products, and/or impurities from the reaction source. Although the mixture may contain catalyst, in an embodiment, the catalyst is removed prior to mixing with the ionic liquid.

TABLE 2

| | HCFO/HFO formed |
|---|---|
| Starting material | via dehydrofluorination |
| 1,1,1,3,3-pentafluoropropane | HFO-1234ze |
| | 1,3,3,3-tetrafluoropropene |
| 3-chloro-1,1,1,3-tetrafluoropropane | HCFO-1233zd |
| | 1-chloro-3,3,3-trifluoropropene |
| 2-chloro-1,1,1,2-tetrafluoropropane | HCFO-1233xf |
| | 2-chloro-3,3,3-trifluoropropene |
| 1,1,1,2,3-pentafluoropropane | HFO-1234yf |
| | 2,3,3,3-tetrafluoropropene |
| 1,1,1,2,2-pentafluoropropane | HFO-1234yf |
| | 2,3,3,3-tetrafluoropropene |
| 1,1,1,2,3,3-hexafluoropropane | HFO-1225ye |
| | 1,2,3,3,3-Pentafluoropropene |

These are illustrative of just a few of the examples of the HF/halogenated hydrocarbon mixture from which the HF may be separated. Regardless of the components in the HF/halogenated hydrocarbon mixture, in accordance with the present invention, the mixture is contacted with an ionic liquid, as described herein. In an embodiment, the mixture may be added to an ionic liquid. In another embodiment, it may be added to an ionic liquid as part of an integrated production facility, for example, an HFC or an HCFC or an HFO or an HCFO production facility. In another embodiment, the ionic liquid is added to the HF/halogenated hydrocarbon mixture.

An ionic liquid, as defined herein, is understood to denote ionic liquids as defined by Wasserscheid and Keim in Angewandte Chemie Int. Eng., 2000, volume 39, pages 3772-3789. Ionic liquids are ionic salts in liquid form of non-molecular, ionic character which melt at relatively low temperatures. The ionic liquids are compounds which have at least one positive charge and contain the anions as described herein. The cations of the ionic liquids contemplated by the present invention can have positive charges that can range in one embodiment, for example, from 1 to 5, inclusive and in another embodiment, 1 to 4, inclusive, and in another embodiment, 1, 2 or 3 and in still another embodiment, 1 for 2 and in still another embodiment, a positive charge of 1. The ionic liquids are overall neutral in charge. They are in the molten state at relatively low temperatures, such as less than 200° C. and in another embodiment, less than 150° C. and in another embodiment, less than 100° C. and in still another embodiment, they have a melting point below 50° C. and in still another embodiment, less than 25° C. In an embodiment, ionic liquids are liquid at ambient temperature (about 20° C.) and ambient pressure (1 bar abs). The ionic liquids are generally non-flammable, non-corrosive, have a low viscosity and are exceptional by having an immeasurable, i.e., non-detectable vapor pressure. Ionic liquids are, for example, suitable as solvents.

It is to be noted that the ionic liquids used in the present process are substantially anhydrous. In an embodiment, the ionic liquid contains, if at all, less than 0.1wt % water, so that any possible hydrolytic reaction takes place in minor amounts, if at all.

As described herein, the ionic liquid contains one or more of the following anions: Cl⁻, F⁻, and (HF)ₙF⁻ (n=1.0−4.0). As defined, n is a real number between 1 and 4 inclusive. For example, n may be an integer or a fraction between 1-4, inclusive.

The ionic liquids used in the present process are prepared by art recognized techniques or are commercially available. For example, 1-ethyl-3-methyl imidazolium chloride (C₆H₁₁N₂Cl) (“EMImCl”) is commercially available from SanKo Chemical Industry, with a purity of greater than 98.5% by weight. The anions can be externally introduced into the process or in-situ generated, or transformed into different forms. For instance, (HF)_{2.3}F⁻ can be formed from the interactions of an ionic liquid with Cl⁻ as anion and HF in the extraction step. Indeed, as reported in Journal of Fluorine Chemistry 99(1999), 1-3, EMImCl, 1-ethyl-3-methyl imidazolium chloride (C₆H₁₁N₂Cl) was converted to EMIm(HF)_{2.3}F(C₆H₁₁N₃F.2.3HF) by reacting EMImCl with HF at room temperature; as reported in an article in the Journal of Physical Chemistry B 109(2005)5445-5449, EMIm(HF)ₙF (n=1.0−2.6) was synthesized by the stoichiometric reaction of EMIm(HF)_{1.0}F and HF. In another example, during vaporization/distillation step, (HF)₂.₃F⁻ can transform into (HF)_{1.0}F⁻ and HF. Indeed, as reported in an article in Journal of Physical Chemistry B 109(2005)5445-5449, and in Solid State Sciences, 2002,4,/23-26, EMIm(HF)_{1.0}F was formed by elimination of HF from EMIm(HF)_{2.3}F at about 130° C.

However, any cation may be present to form an ionic liquid, as long as the resulting ionic liquid meets the criteria of an ionic liquid, as defined herein. The cations, in an embodiment, may have a +1, +2, +3 +4 or +5 charge.

The cations of ionic liquids applicable in the present invention may have one or more positive charges. In an embodiment, cations with one positive charge, +1, is present in the ionic liquid used in the present invention, while in another embodiment, the cation may have a +2, +3, +4 or +5 charge.

Cations which are suitable for the ionic liquids of the present invention are described in U.S. Pat. No. 7,435, 318, as for example, in column 3, line 1 to column 10, line 15, the contents of which are incorporated by reference. Examples of cations used in the ionic liquids of the present invention include ammonium, guanidinium and/or phosphonium ions. Generally, the ionic liquids are selected such that they do not react chemically with a component of the mixture to be separated, thereby minimizing the risk that the components of the mixture would undergo reactions or decompose. This can be ascertained by simple tests. If the mixture comprises constituents which are sensitive towards moisture, it is advisable to essentially exclude moisture, for example, by means of drying agents in the reactor, flushing with dry inert gas or similar treatments.

In an embodiment of the present invention, the ionic liquid of the present invention contains a cation which contains nitrogen. In principle, all known ammonium cations which comprise at least one organic substituent can be utilized. In general, these are primary, secondary, tertiary or quaternary ammonium cations. The cations in an embodiment have the formula R1R2R3R4N⁺, wherein R1, R2, R3, and R4 are the same or different and are H, alkyl having 1 to 12 carbon atoms, aryl, such as phenyl or naphthyl, or arylalkyl, wherein alkyl is 1-12 atoms, wherein at least one of R1, R2, R3 and R4 is other than hydrogen. For example, the substituents can be linear or branched alkyl groups, for example, an alkyl having 1 to 12 carbon atoms. In another embodiment, the alkyl group substituent contains 1-6 carbon atoms, and in another embodiment, contains 1-4 carbon atoms, and in still another embodiment, the alkyl group contains 1-3 carbon atoms. The alkyl groups substituted on the nitrogen atom can be the same or different. The substituents on the nitrogen atom can likewise be aromatic groups, for example, phenyl group which, if desired, can be optionally monosubstituted or multiply substituted, for example, by one or more C1 to C12 alkyl groups and in another embodiment, C1 to C6 alkyl groups, and in another embodiment, C1-C4 alkyl groups, and in another embodiment, C1-C3 alkyl groups. The substituents can also be arylalkyl groups, for example, benzyl groups.

As used herein, unless indicated to the contrary, the term “alkyl”, when used alone or in combination with other term, denotes an alkyl group having 1-12 carbon atoms. The alkyl group may be straight-chained or branched. Examples include methyl, ethyl, propyl, isopropyl, n-butyl, isobutyl, sec-butyl, tert-butyl, n-pentyl, isopentyl, neopentyl, n-hexyl, and the like. The term “aryl,” as used herein, alone or in combination, refers to an aromatic ring containing only carbon atoms, such as 6 or 10 ring carbon atoms. Examples include phenyl, naphthyl, and the like.

Guanidinium cations (R1R2N—C(═NH)NR3R4)⁺ and isouronium cations (R3-O—N═NR1R2)⁺, wherein R1, R2 and R3 are as defined heretofore, are suitable cations, too (such compounds are available from Merck, Darmstadt). Such groups may be unsubstitutued or substitiuted. Substituents at nitrogen atoms and oxygen atoms can be linear or branched alkyl groups, for example, having 1 to 12 carbon atoms, or in another embodiment, 1-6 carbon atoms, or in another embodiment, 1-4 carbon atoms or in another embodiment, 1-3 carbon atoms. The guanidinium and isouronium cations may, in another embodiment, substituted with aryl groups or arylalkyl groups, where alkyl is heretofore defined, or they may be substituted with a combination of alkyl, aryl and arylalkyl, as defined herein.

Heterocyclic compounds which comprise at least one ring nitrogen atom and optionally an oxygen ring or sulfur ring atom , including those mentioned in WO 02/074718 on pages 4 to 6 thereof , are suitable as cations, too. In an embodiment, the heterocyclic cations include cyclic structures containing 3 to 10 ring atoms, having 1-9 ring atoms and at least one nitrogen ring atom and optionally 1 or 2 ring oxygen atoms, said oxygen ring and sulfur ring atoms are on non-adjacent positions on the ring. i.e., a sulfur atom on the ring is not adjacent to another sulfur atom or oxygen atom on the ring and the oxygen atom on the ring is not adjacent or a sulfur or oxygen atom on the ring. However, an oxygen ring atom or sulfur ring atom may be adjacent to a carbon ring atom or a nitrogen ring atom. The heterocyclic cations may be monocyclic or bicyclic. These heterocyclic cations are optionally substituted cations based on the structure of nitrogen containing heterocyclics, such as pyridine, pyridazine, pyrimidine, pyrazine, imidazole, oxatriazolium, thiatriazolium,1H-pyrazole, 3H-pyrazole, 4H-pyrazole, 1-pyrazoline, 2-pyrazoline, 3-pyrazoline, 1-imidazoline, 2-imidazoline, 4-imidazoline, thiazole, oxazole, 1,2,4-triazole (positive charge on the 2-nitrogen or 4-nitrogen atom, respectively), 1,2,3-triazole (positive charge on the 2-nitrogen or 3-nitrogen atom, respectively), and the like. Examples are provided in U.S. Pat. No. 7,435, 318 in column 3, line 1 to column 10, line 15, the contents of which are incorporated by reference. Cations of N-alkylisochinoline, alkyltriazolium, or N-alkylimidazoline are likewise suitable. These heterocyclic compounds can be unsubstituted (i.e., substituted by hydrogen at all positions) or optionally substituted by, for example, alkyl groups with 1 to 12 carbon atoms (in a C2-C12 alkyl, carbon atoms in the chain may be substituted by one or more oxygen or sulfur atoms or imino groups in the chain, provided there are no two adjacent oxygen atoms, sulfur atoms or oxygen and sulfur atoms), C6 to C 12 aryl groups, arylalkyl, C5 to C 12-cycloalkyl (wherein cycloalkyl is monocyclic or bicyclic and contains 5-12 ring carbon atoms, such as cyclopentyl, cyclohexyl, cycloheptyl, cyclooctyl, cyclononyl or decalinyl)or a 5-membered or 6-membered heterocyclic group with one to four nitrogen ring atoms , or one to two non-adjacent ring atoms selected from oxygen and sulfur atoms. Two of the substituents can, if taken together, form an unsaturated or saturated alkyl or aromatic ring which may comprise one or oxygen atoms, sulfur atoms or imino groups in the chain. These substituents can themselves be substituted by functional groups, such as aryl, alkyl, aryloxy, alkoxy having 1 to 6 carbon atoms, hydroxyl, cyano, halogen, and the like. In an embodiment, one or more ring nitrogen atoms are substituted by alkyl, containing 1-12 carbon atoms, C1-C18-alkylcarbonyl, C1-C18-alkyloxycarbonyl, C5-C12-cycloalkylcarbonyl or C6-C12-arylcarbonyl can, for example, be substituents of a nitrogen atom which carries the positive charge; once again, also these substituents can be themselves substituted by functional groups, such as aryl, alkyl, aryloxy, alkoxy, halogen, and the like. In an embodiment, the nitrogen ring atoms are substituted by hydrogen or alkyl containing one to four carbon atoms.

Cyclic saturated ammonium cations, which may be utilized in the present invention, include, for example, optionally substituted mono or bicyclic saturated ammonium cations, such as piperidinium or piperidinium substituted by hydroxy groups, or pyrrolidinium or pyrrolidinium substituted by hydroxyl. Also the cations of bicyclic amines can also be used, especially those of 1,5-diazabicyclo[4.3.0]non-5-ene and 1,8-diazabicyclo[5.4.0]-undec-7-ene, as well as cyclic amines substituted by amino groups like dialkylaminopiperidine and dialkylaminopiperazine (wherein alkyl groups here maybe the same or different and denotes here C1 to C12, for example C1 to C4).

Oligomers and polymers which comprise the cations described above (see for example, M. Yoshizawa, W. Ogihara and H. Ohno, Polym. Adv. Technol. volume 13, pages 589-594, 2002) can also be utilized,

Phosphorous containing cations are also suitable, such as phosphonium cations which are substituted by hydrogen atoms or where one or more hydrogen atoms are replaced with alkyl groups which may be the same or different, where alkyl contains 1 to 12 carbon atoms, such as butyl or octyl, or replaced by aryl, such as phenyl or replaced by arylalkyl.

In an embodiment, the cations of the ionic liquids include ammonium, sulfonium, phosphonium, imidazolium, pyridinium, pyrrolidinium, thiazolium, triazolium, oxazolium, and pyrazolium. In another embodiment, the cations include ammonium, phosphonium, imidazolium, pyridinium, and pyrrolidinium. In an embodiment, the cations include imidazolium, pyridinium, pyrrolidinium, and their combinations. For example, the cation in the ionic liquid is imidazolium. Non-limiting examples of imidazolium include, but are not limited to, 1-methylimidazolium, 1-ethylimidazolium,l-propylimidazolium, 1-buylimidazolium, 1,2-dimethylimidazolium, 1,3-dimethylimidazolium, 1-ethyl-3-methylimidazolium, 1-n-butyl-3-methylimidazolium, 1-n-butyl-3-ethylimidazolium, 1,3-di-n-butylimidazolium, 1-methyl-3-octylimidazolium, 1-decyl-3-methylimidazolium, 3-butyl-1-methylimidazolium, 3-butyl-1-ethylimidazolium, 3-methyl-2-ethylimidazolium, 3-butyl-2-methylimidazolium, 3-butyl-2-ethylimidazolium, 3,4-dimethylimidazolium, 3-butyl-4-methylimidazolium, 1,2,3-trimethylimidazolium, 1-butyl-2,3-dimethylimidazolium, 1,3-dibutyl-2-methylimidazolium, 3-butyl-1,2-dimethylimidazolium, 1,3,4-trimethylimidazolium, 3-butyl-1,4-dimethylimidazolium, 2-ethyl-3,4-dimethylimidazolium, 3-butyl-2-ethyl-4-methylimidazolium, 1,3,4,5-tetramethylimidazolium, 3-butyl-1,4,5-trimethylimidazolium, and their combinations. Very suitable are ionic liquids with 1,3-dimethyl-imidazolium, 1-ethyl-3-methyl-imidazolium (“EMIM”), 1-propyl-3-methyl-imidazolium and 1-n-butyl-3-methyl-imidazolium (“BMIM”) as cation, and their combinations.

In an embodiment the ionic liquid utilized in the present process includes 1-ethyl-3-methylimodazolium chloride (EMImCl), EMIm (HF)F, and EMIm (HF)₂₃F, where 1-ethyl-3-methylimodazolium is abbreviated as EMIm.

As is quite apparent, the cations are spectator ions.

In the process of the present invention, the mixture of HF/halogenated products of the reaction is separated from the reaction vessel by methods known to one of ordinary skill in the art. Any catalyst, if any, used in the making the mixture of HF/halogenated process should be removed from the mixture. The ionic liquid of the present invention is placed into contact with the mixture of HF/halogenated hydrocarbons. In an embodiment, the mixture is added to the ionic liquid, and then the resulting product is thoroughly or intimately mixed and then the mixture is allowed to stand for the HF present to become separated into the ionic liquid phase. In another embodiment, the ionic liquid is added into a mixture of HF/halogenated hydrocarbons and after thorough and intimate mixing, the resulting mixture is allowed to stand to allow HF to enrich in the ionic liquid phase. After phase separation, the HF enriched ionic liquid is then subjected to vaporization/distillation to recover HF. Due to negligible vapor pressure of the ionic liquid, extremely pure HF is obtained. The mixing and the extraction step are conducted at or about room temperature or at slightly elevated temperatures, such as from room temperature to about 50° C. The recovered ionic liquid can be recycled/re-used.

In certain embodiments, the extracting step comprises introducing a stream of ionic liquid to the provided HF/halogenated hydrocarbon mixture to dissolve at least a portion of the HF present therein. As will be readily understood by those of skill in the art, due at least in part to the solubility/polarity characteristics of the selected ionic liquid, HF, and halogenated hydrocarbon(s), upon introducing ionic liquid to an HF/halogenated hydrocarbon mixture, two separable phases typically form: an upper halogenated hydrocarbon phase, in which the concentration of halogenated hydrocarbon(s) is increased compared to that in the original HF/halogenated hydrocarbon mixture, and a lower ionic liquid phase, in which HF is enriched. After the introduction of the ionic liquid, the concentration of halogenated hydrocarbon(s) is increased by at least 1 mol % in one embodiment, at least 10 mol % in another embodiment, at least 50 mol % in another embodiment, and at least 95 mol % in yet another embodiment.

Any suitable amount of ionic liquid can be used to extract HF from the provided mixture according to the present invention. As will be understood by those of skill in the art, the amount of ionic liquid used depends at least in part on the amount of HF present in the provided mixture and the solubility of HF in the ionic liquid used. In certain embodiments, the weight ratio of ionic liquid to HF used is from about 0.1:1 to about 100:1. In other embodiments, the weight ratio is from about 1:1 to about 20:1, while in another embodiment, the weight ratio ranges from about 2:1 to about 15:1, and, in still another embodiment, from about 5:1 to about 10:1.

The ionic liquid stream may be introduced to the halogenated hydrocarbon/HF mixture via any suitable method. For example, a liquid stream of ionic liquid may be introduced to a halogenated hydrocarbon/HF mixture by pouring, decanting, injecting, pumping, or otherwise contacting the ionic liquid stream with the halogenated hydrocarbon/HF mixture in an open or closed vessel, such as, a packed column, a standard scrubbing tower, beakers, flasks, and the like. In certain embodiments, the extraction step comprises introducing a liquid stream of ionic liquid to a halogenated hydrocarbon/HF mixture in the gaseous phase by introducing the ionic liquid to the top of a packed column into which the halogenated hydrocarbon/HF mixture is introduced from the bottom of the column. As will be recognized by those of skill in the art, in such embodiments, the ionic liquid stream will tend to travel down the column, while the gaseous provided mixture will tend to travel up the column such that the two streams will contact each other and at least a portion of the HF in the provided mixture will be dissolved into the ionic liquid.

In accordance with the present invention, in an embodiment, to promote maximum contact with the ionic liquid, the HF/halogenated hydrocarbon mixture is thoroughly mixed with the ionic liquid described herein. After mixing, the mixture is allowed to stand for a time sufficient for phase separation to occur so that the HF will separate into the HF enriched ionic liquid layer.

After the ionic liquid and provided mixture streams are introduced to form two separable phases, the phases are then separated by techniques known in the art and HF is recovered from the bottom ionic liquid phase. Any suitable method of separating can be used. For example, suitable liquid phase separation techniques include decanting, siphoning, distillation, and the like. Suitable methods for gas-phase or combination gas/liquid phase separation include introducing the streams into a packed column, as described hereinabove, wherein top gas phase exits one direction (usually top) and bottom phase other direction (usually bottom), or other known methods of gas-phase gas/liquid phase separation.

According to certain embodiments, the HF extracted from the provided mixture as described above may be further purified by separating the HF obtained from the mixture known to one of ordinary skill in the art. For example, in one embodiment, the mixture is distilled to separate HF from the ionic liquid extractive agent. Any suitable method of distillation may be used in the present invention. Examples of suitable distillation techniques include simple distillation, flash distillation, fractionation, combinations of two or more thereof, and the like. In certain embodiments, the present methods involve both flash distillation and conventional column fractionation distillation.

For example, in an embodiment, the HF is separated from the ionic liquid extractive agent by flash distillation. Any distillation conditions and apparatus effective to flash distill HF from a mixture comprising HF and ionic liquid can be used according to the present methods. For example, suitable flash distillation temperatures include temperatures of from about 20° C. to about 250° C. In another embodiment, the flash distillation temperatures include those of from about 50° C. to about 200° C., and in another embodiment, from about 50° C. to about 180° C., and in another embodiment, from about 80° C. to about 150° C. In light of the disclosure herein, those of skill in the art will be readily able to remove HF from an extraction layer comprising HF and ionic liquid without undue experimentation. Pressure is not critical. Thus, the process described herein can be conducted at atmospheric, superatmospheric, or subatmospheric pressures. Thus atmospheric or slightly higher than atmospheric pressures can be utilized. For example, the pressure can range from about 1 to about 10 atm.

The separated ionic liquid can be recycled or reused, while the separated HF can be further processed. Any of a wide range of conventional column fractionation distillation apparatus and techniques can be used according to the present invention to obtain relatively pure anhydrous HF from an HF product obtained from a flash distillation step according to the present invention. For example, suitable distillation temperatures include temperatures of from about 16° C. to about 85° C. at atmospheric pressure. In another embodiment, the distillation temperatures include those of from about 19° C. to about 75° C., and in another embodiemtn from about 19.5° C. to about 65° C. at atmospheric pressure. Pressure is not critical, atmospheric, superatmospheric, and subatmospheric are acceptable, but atmospheric or slightly higher than atmospheric pressures are preferred.

The HF/halogenated hydrocarbon mixture from which anhydrous HF is extracted in accordance with the present invention can be a gas phase stream, a liquid phase stream, or a combination of liquid and gas phases.

The following are examples of the invention, which should not be construed as limiting. Examples 1-4 are prophetic examples.

### EXAMPLE 1

This example demonstrates the efficacy of HF removal from HF/halogenated hydrocarbon mixture according to the present invention.

The HF removal from the mixture containing HCFC-244bb, HCFO-1233xf, and HF is performed at room temperature. A 500 ml SS sample cylinder is used for the study. The cylinder is equipped with sampling valves at the bottom and the top of the cylinder. To the cylinder, 292 g of EMImCl ionic liquid is firstly charged, and then a pre-made HF/organic mixture containing 40 g of HF, 125 g of HCFC-244bb, and 5 g of HCFO-1233xf is charged. The combined 244bb and 1233xf concentration in original HF/organic mixture is about 30.3 mol %. The weight ratio of ionic liquid/HF is about 7.3:1. The cylinder is vigorously shaken for 5 minutes and then the mixture is allowed to stand for at least 30 minutes prior to proceeding to next step. The generated HCl is then vented to a caustic solution carboy through the top of the cylinder.

To separate ionic liquid layer from halogenated hydrocarbon layer, 332 g (equivalent to the sum of amounts of EMImCl ionic liquid and HF) of sample is taken from the bottom of the cylinder into a Teflon container and then the rest (halogenated hydrocarbon layer sample) into a Tedlar gas sample bag that contained 5 g of distilled water for the purpose of absorbing HF. HF concentration of the aqueous phase of the sample bag is determined by titration with 0.1 N KOH aqueous solution. HF concentration in halogenated hydrocarbon layer is calculated to be 1.3 mol %. In other words, the combined 244bb and 1233xf concentration after separation is 98.7 mol %, which is significantly higher than 30.3 mol % in the original provided mixture.

### EXAMPLE 2

This example demonstrates the efficacy of HF removal from HF/halogenated hydrocarbon mixture according to the present invention.

The HF removal from the mixture containing HCFC-244bb, HCFO-1233xf, and HF is performed at room temperature. A 500 ml SS sample cylinder is used for the study. The cylinder is equipped with sampling valves at the bottom and the top of the cylinder. To the cylinder, 312 g of EMIm(HF)_{2.3}F ionic liquid is firstly charged, and then a pre-made HF/organic mixture containing 35 g of HF, 120 g of HCFC-244bb, and 4 g of HCFO-1233xf is charged. The combined 244bb and 1233xf concentration in original HF/organic mixture is about 32.1 mol %. The weight ratio of ionic liquid/HF is about 8.9:1. The cylinder is vigorously shaken for 5 minutes and then the mixture is allowed to stand for at least 30 minutes prior to proceeding to next step.

To separate ionic liquid layer from halogenated hydrocarbon layer, 347 g (equivalent to the sum of amounts of EMIm(HF)_{2.3}F ionic liquid and HF) of sample is taken from the bottom of the cylinder into a Teflon container and then the rest (halogenated hydrocarbon layer sample) into a Tedlar gas sample bag that contained 5 g of distilled water for the purpose of absorbing HF. HF concentration of the aqueous phase of the sample bag is determined by titration with 0.1 N KOH aqueous solution. HF concentration in halogenated hydrocarbon layer is calculated to be 11.5 mol %. In other words, the combined 244bb and 1233xf concentration after separation is 88.5 mol %, which is significantly higher than 32.1 mol % in the original provided mixture.

### EXAMPLE 3

This example demonstrates the efficacy of HF removal from HF/halogenated hydrocarbon mixture according to the present invention.

The HF removal from the mixture containing HCFC-244bb, HCFO-1233xf, and HF is performed at 40° C. A 500 ml SS sample cylinder is used for the study. The temperature of the cylinder is controlled with heating tape wrapped around the cylinder. A thermocouple is attached to the outside wall of the cylinder (between heating tape and the cylinder wall) and positioned in the middle of the cylinder to measure the temperature. The cylinder is equipped with sampling valves at the bottom and the top of the cylinder. To the cylinder, 232 g of EMIm(HF)F ionic liquid is firstly charged, and then a pre-made HF/organic mixture containing 31 g of HF, 112 g of HCFC-244bb, and 3 g of HCFO-1233xf is charged. The combined 244bb and 1233xf concentration in original HF/organic mixture is about 33.1 mol %. The weight ratio of ionic liquid/HF is about 7.5:1. After being heated and reaching 40° C., the cylinder is vigorously shaken for 5 minutes and then the mixture is allowed to stand for at least 30 minutes prior to proceeding to next step.

To separate ionic liquid layer from halogenated hydrocarbon layer, 263 g (equivalent to the sum of amounts of EMIm(HF)F ionic liquid and HF) of sample is taken from the bottom of the cylinder into a Teflon container and then the rest (halogenated hydrocarbon layer sample) into a Tedlar gas sample bag that contained 5 g of distilled water for the purpose of absorbing HF. HF concentration of the aqueous phase of the sample bag is determined by titration with 0.1 N KOH aqueous solution. HF concentration in halogenated hydrocarbon layer is calculated to be 6.1 mol %. In other words, the combined 244bb and 1233xf concentration after separation is 93.9 mol %, which is significantly higher than 33.1 mol % in the original provided mixture.

EXAMPLE 4

This example demonstrates the efficacy of HF recovery from HF enriched ionic liquid layer according to the present invention.

A 500 ml SS sample cylinder with a dip tube and vapor port on the top is used for the study. The temperature of the cylinder is controlled with heating tape wrapped around the cylinder. A thermocouple is attached to the outside wall of the cylinder (between heating tape and the cylinder wall) and positioned in the middle of the cylinder to measure the temperature.

263 g of ionic liquid layer sample collected in Example 3 is transferred to this 500 ml SS sample cylinder. A N₂ flow is introduced to the cylinder through the dip tube and exits from vapor port, from which a water bubbler (containing 500 g of distilled water) is installed down-stream to collect HF released. The cylinder is heated to 80° C. and maintain at this temperature during the experiment. After 10 hours, the N₂ flow is stopped and HF concentration in water sample is determined by titration with 0.1 N KOH aqueous solution. The amount of HF collected in water bubbler is calculated to be 25 g.

It is to be understood that both the general description herein is exemplary and explanatory only and is not restrictive of the invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention. Other embodiments will be apparent to those skilled in the art from consideration of the specification and practice of the invention disclosed herein.

What is claimed is:

1. A method for recovering HF from a mixture comprising HF and a halogenated hydrocarbon comprising contacting the mixture with an ionic liquid, wherein the ionic liquid is a salt and wherein the anion of the ionic liquid is Cl⁻, F⁻, and (HF)ₙF⁻, wherein n is a positive number ranging from 1 to 4, inclusive, or combination thereof to produce a product comprised of HF and said ionic liquid, the weight ratio of the ionic liquid to HF ranging from about 0.1:1 to about 100:1, and extracting therefrom a solution comprised of HF and separating HF from said solution.

2. The method according to claim 1 wherein the extracting step comprises thoroughly mixing said ionic liquid with the mixture comprising HF and a halogenated hydrocarbon and then allowing the mixture to separate into an ionic liquid phase comprised of and enriched with HF and a second phase comprised of and enriched with the halogenated hydrocarbon.

3. The method according to claim 1 wherein the weight ratio of ionic liquid to HF ranges from about 1:1 to about 20:1.

4. The method according to claim 1 wherein the weight ratio of ionic liquid to HF ranges from about 2:1 to about 15:1.

5. The method according to claim 1 wherein the weight ratio of ionic liquid to HF ranges from about 5:1 to about 10:1.

6. The method according to claim 1 wherein the contacting step comprises adding ionic liquid to the mixture comprising HF and at least a halogenated hydrocarbon.

7. The method according to claim 1 conducted at about room temperature and at about atmospheric pressure.

8. The method according to claim 1 wherein the ionic liquid phase comprised of HF is separated from the second phase comprised of and enriched in the halogenated hydrocarbon by decanting the phase enriched with the halogenated hydrocarbon from the ionic phase enriched with HF or by siphoning the ionic liquid phase enriched with HF from the phase enriched with halogenated hydrocarbon.

9. The method according to claim 8 which further comprises separating the HF from the ionic liquid phase.

10. The method according to claim 9 wherein the HF is separated from the ionic liquid phase by distillation.

11. The method according to claim 1 wherein the cation of the ionic liquid is R1R2R3R4N⁺, R1R2N—C(═NH)NR3R4)⁺ or (R3-O—N═NR1R2)⁺, wherein R1, R2, R3, and R4 are the same or different and are H, alkyl having 1 to 12 carbon atoms, aryl, or arylalkyl, wherein alkyl is 1-12 atoms and wherein at least one of R1, R2 and R3 is other than hydrogen.

12. The method according to claim 1 wherein the cation of the ionic liquid is piperidinium or piperidinium substituted by hydroxy groups, or pyrrolidinium or pyrrolidinium substituted by hydroxyl, 1,5-diazabicyclo[4.3.0]non-5-ene, 1,8-diazabicyclo[5.4.0]-undec-7-ene, dialkylaminopiperidine or dialkylaminopiperazine , wherein alkyl independently contains 1-4 carbon atoms.

13. The method according to claim 1 wherein the cation of the ionic liquid is ammonium, sulfonium, phosphonium, imidazolium, pyridinium, pyrrolidinium, thiazolium, triazolium, oxazolium, and pyrazolium.

14. The method according to claim 1 wherein the cation of the ionic liquid is ammonium, phosphonium, imidazolium, pyridinium, or pyrrolidinium.

15. The method according to claim 14 wherein the cation of the ionic liquid is imidazolium.

16. The method according to claim 15 wherein imidazolium is 1-methylimidazolium, 1-ethylimidazolium,1 -propylimidazolium, 1 -butylimidazolium, 1,2-dimethylimidazolium, 1,3-dimethylimidazolium, 1-ethyl-3-methylimidazolium, 1-n-butyl-3-methylimidazolium, 1 -n-butyl-3 -ethylimidazolium, 1,3 -di-n-butylimidazolium, 1-methyl-3-octylimidazolium, 1-decyl-3-methylimidazolium, 3-butyl-1-methylimidazolium, 3-butyl-1-ethylimidazolium, 3-methyl-2-ethylimidazolium, 3-butyl-2-methylimidazolium, 3-butyl-2-ethylimidazolium, 3,4-dimethylimidazolium, 3-butyl-4-methylimidazolium, 1,2,3-trimethylimidazolium, 1-butyl-2,3-dimethylimidazolium, 1,3-dibutyl-2-methylimidazolium, 3-butyl-1,2-dimethylimidazolium, 1,3,4-trimethylimidazolium, 3-butyl-1,4-dimethylimidazolium, 2-ethyl-3,4-dimethylimidazolium, 3-butyl-2-ethyl-4-methylimidazolium, 1,3,4,5-tetramethylimidazolium, 3-butyl-1,4,5-trimethylimidazolium, and their combinations.

17. The method according to claim 1 wherein the HF is separated from a mixture of halogenated hydrocarbons comprised of 1,1,1,3,3-pentafluoropropane, 1-chloro-3,3,3-trifluoropropene, 1,3,3,3-tetrafluoropropene.

18. The method according to claim 1 wherein the HF is separated from a mixture of halogenated hydrocarbons comprised of 2,3-dichloro-3,3- difluoropropene and 2-chloro-3,3,3- trifluoropropene.

19. The method according to claim 1 wherein the HF is separated from a mixture of halogenated hydrocarbons comprised of 2-chloro-1,1,1,2-tetraflurorpropane and 1,1,1,2,2-pentafluoropropane.

20. The method according to claim 1 wherein the HF is separated from a composition comprising 1,1,1,2-tetrafluoroethane.

21. The method according to claim 1 wherein the HF is separated from a mixture of halogenated hydrocarbons comprising 2,2-dichloro-1,1,1-trifluoroethane, 2-chloro-1,1,1,2-tetrafluoroethane, 1,1,1-trifluoroethane.

22. The method according to claim 1 wherein the HF is separated from a composition comprising 1,1,1-trifluoroethane.

23. The method according to claim 1 wherein the HF is separated from a composition comprising chlorodiflurormethane.

24. The method according to claim 1 wherein the HF is separated from a composition comprising difluoromethane.

25. The method according to claim 1 wherein the HF is separated from a composition comprising 1,1,1,3,3,3-hexafluoropropane.

26. The method according to claim 1 wherein the HF is separated from a composition comprising 1,2,3,3,3-pentafluoropropene.

27. The method according to claim 1 wherein the HF is separated from a composition comprising 1,3,3,3-tetrafluoropropene.

28. The method according to claim 1 wherein the HF is separated from a composition comprising 1-chloro-3,3,3-trifluoropropene.

29. The method according to claim 1 wherein the HF is separated from a composition comprising 2-chloro-3,3,3- trifluoropropene.

30. The method according to claim 1 wherein the HF is separated from a composition comprising 2,3,3,3-tetrafluoropropene.

31. The method according to claim 1 wherein the HF is separated from a composition comprising 1,2,3,3,3-pentafluoropropene.
